(19) United States
(12) Patent Application Publication
(10) Pub. No.: US 2007/0023537 A1
(43) Pub. Date: Feb. 1, 2007

(54) Digital thermostat analyzer ("DTA-7")

(76) Inventor: Ronald Joseph Bennett, Archer, FL (US)

Correspondence Address: RONALD JOSEPH BENNETT, 9808 SW 170TH STREET, ARCHER, FL, 32618, US

(21) Appl. No.: 11/189,474

(22) Filed: Jul. 26, 2005

(51) Int. Cl. G05D 23/00

(52) U.S. Cl. 236/94

(57) ABSTRACT

This device gives a user/technician the ability to test a digital thermostat as a component in an HVAC system. A thermostat must have control voltage to send to the individual components which comprise a heating and/or cooling system. This device lets the user/technician see, by visual indicators when circuits are being closed or opened by the thermostat being tested.

### CROSS REFERENCE TO RELATED APPLICATIONS

Not Applicable.

### FEDERALLY SPONSORED RESEARCH OR DEVELOPMENT

Not Applicable

### SEQUENCE LISTING OR PROGRAM

Not Applicable

### BACKGROUND OF THE INVENTION

This device has been invented to overcome the difficulties for an individual or technician in the Heating, Ventilation, and Air Conditioning (HVAC) industry to test a digital thermostat for function.

Thermostats are currently being manufactured to be programmable for multiple applications. Programming errors that occur are in many cases very difficult to determine because of the design of the thermostat.

Many thermostats are being manufactured with a two part design. These parts include: 1) a base that connects control wires to the individual components to be controlled and 2) a thermostat which directs control voltage to the same components.

A problem arising from this design is the difficulty encountered to determine if the thermostat is directing control voltage to the individual components when the interface contacts are closed inside the thermostat after final assembly. These components are usually located indifferent geographic locations and are in many cases usually difficult to access. Control voltage supplied to the thermostat usually originates from a transformer and is directed through the thermostat, but the thermostat must remain closed for the control circuits to be completed. When the thermostat installation is complete there is no longer access to the contact point that needs to be tested. This is where the problem occurs.

### BRIEF SUMMARY OF THE INVENTION

This device is a diagnostic tool that gives the user the ability to see whether a thermostat is directing control voltage to the correct components. The user will connect the thermostat directly to the device, and then runs a series of industry standardized tests to see if the thermostat is functioning correctly. When the thermostat is tested, a series of light emitting diodes (LED's) are activated to indicate proper function and circuit closure.

### DETAILED DESCRIPTION OF THE INVENTION

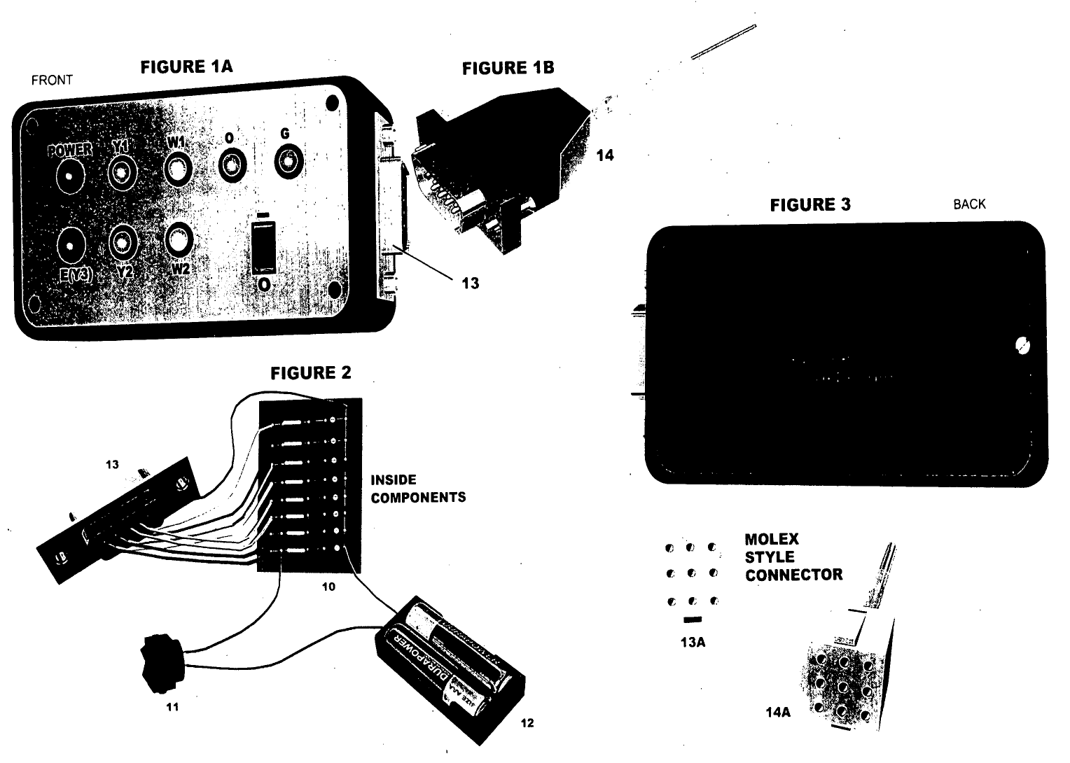

The preferred embodiment for the DTA-7 will be a plastic enclosure (FIG. 1A) with a connector (FIG. 1B).

The device is powered by a three volt negative ground power source (12). Two 1.5 volt batteries have been installed in the back battery compartment (FIG. 3) and connected in series to generate the power needed to energize the indicator LED's.

All components within the enclosure (FIG. 2) are connected to a printed circuit board or PCB (10). The positive side of the power source is connected to a single pole single throw switch or SW1 (11) used to activate the device. Switched power then continues to a shared terminal with; 1) series resistor R1 (47 ohm) which reduces voltage to design level for LED 1, and 2) pin one of a nine pin connector.

The nine pin connector is labeled a terminal interface or TI (FIG. 1B) consists of two parts. The female side of the TI (13) is connected (housed) inside the preferred embodiment of the DTA-7 and the male side (14) is connected through wire extension to the test thermostat. The TI is simply the means to connect the test thermostat to the DTA-7. An alternate TI connector may also be used (13A) (14A). Pin one is used for control voltage for the test and is directed to the thermostat being tested. When SW1 is closed, the power circuit is completed energizing R1/LED1 and indicating the device is operating. Ground from power source is also connected to a shared terminal on PCB and to pin five of the TI.

In a normal test environment a thermostat can have multiple stages of cooling. Industry standard for labeling cooling circuits are Y1, Y2, and Y3. Y1 is stage one of cooling & continues respectively. Depending on programmed set points and demand for the application being tested, the switched voltage coming back from the test thermostat may activate additional cooling circuits for Y2 and Y3 if the system is so equipped. When the test thermostat cooling circuits close, voltage returns to the device through TI pins two, three, and four for their respective cooling stages. Stage one cooling sends voltage to a series resistor R2 which reduces voltage to design level for LED 2 energizing it and showing user that the circuit has been completed. Additional cooling circuits operate identically for stages two and three respectively, energizing circuits R3-LED3 and R4-LED4 respectively.

It is also common to have multiple stages of heating. Industry standard for labeling heating circuits are W1 and W2. These circuits return from the test thermostat on pins eight and nine respectively, and operate the same as cooling circuits energizing R5-LED5 and R6-LED6 respectively.

Some HVAC systems are designed to use the same refrigerant circuit that cools, for heating purposes as well. This is accomplished through a reversing valve. The industry standard for labeling this circuit is orange/blue. The control voltage for the reversing valve circuit comes back to the device through pin seven and energizes R7-LED7.

The final circuit in this device is to analyze the fan control. The industry standard for labeling the fan circuit is green. Control voltage for the fan circuit comes back to the device on pin six, energizing R8-LED8.

This device has been designed with the anticipation that only two cooling circuits will need to be tested and so the Y3 circuit has dual labeling with an E terminal. Industry standard dedicates E for emergency heat, or a circuit that runs independently of the other heat circuits W1 and W2.

All components of the device are then secured & sealed in the enclosure.

1. A device for performing industry standardized isolation testing of an HVAC digital thermostat switching control voltage output, consisting of the principle embodiment housing a power supply, a power switch, eight individual series resistor/LED circuits, and a multipin connector for interfacing said device and the thermostat being tested.
